(19) United States
(12) Patent Application Publication
(10) Pub. No.: US 2026/0318354 A1
(43) Pub. Date: Oct. 15, 2026

(54) BEARING AND BEARING ARRANGEMENT

(71) Applicant: Vibracoustic SE, Weinheim (DE)

(72) Inventors: David Rose, Hamburg (DE); Steffen Nitschke, Hamburg (DE); Dominik Von Borell du Vernay, Gyhum (DE); Philipp Werner, Lüneburg (DE)

(21) Appl. No.: 19/573,654

(22) Filed: Mar. 20, 2026

(30) Foreign Application Priority Data
Mar. 24, 2025 (DE) 10 2025 111 345.9

(51) Int. Cl. F16C 29/00

(52) U.S. Cl. CPC F16C 29/002

(57) ABSTRACT

Please substitute the following paragraph(s) for the Abstract now appearing in the currently filed specification:

A bearing with a longitudinal axis includes an inner sleeve, an outer sleeve that surrounds the outer circumference of the inner sleeve to form an intermediate space, and an elastomer body in the intermediate space, which elastomer body elastically connects the inner sleeve to the outer sleeve. In embodiments, the elastomer body is connected in a materially bonded manner only to the inner sleeve or only to the outer sleeve. The bearing may comprise at least one axial stop, including a first stop running in the circumferential direction on one of the inner sleeve and outer sleeve and a second stop running in the circumferential direction on the other of the inner sleeve and outer sleeve. The first stop and the second stop may have an overlap with each other in the axial direction and an axial clearance between their contact surfaces.

### TECHNICAL FIELD

The invention relates to a bearing and to a bearing arrangement.

Bearings with an inner sleeve, an outer sleeve and an interposed elastomer body are known.

### BACKGROUND

It is known to achieve a high degree of axial stiffness through geometries of inner sleeve and outer sleeve which form an axial overlap with each other and bear against the elastomer body. However, no axial stop is formed in this way.

A disadvantage of such bearings, however, is the absence of a jump in progression in the axial direction.

### SUMMARY

An object is to provide an improved axially stiff bearing in which an additional jump in progression in the axial direction is achieved.

Features according to the disclosure are specified herein. Embodiments are also disclosed.

According to the disclosure, a bearing is proposed through which there runs a longitudinal axis, comprising an inner sleeve, an outer sleeve which surrounds the outer circumference of the inner sleeve to form an intermediate space, and an elastomer body in the intermediate space, which elastomer body elastically connects the inner sleeve to the outer sleeve, wherein the elastomer body is connected in a materially bonded manner only to the inner sleeve or only to the outer sleeve, wherein the bearing comprises at least one axial stop, comprising a first stop running in the circumferential direction on one of the inner sleeve and outer sleeve and a second stop running in the circumferential direction on the other of the inner sleeve and outer sleeve, wherein the first stop and the second stop have an overlap with each other in the axial direction and an axial clearance between their contact surfaces.

Thus, an axially stiff bearing has been found in which a jump in stiffness in the bearing itself is achieved with the aid of the at least one axial stop.

In an embodiment, an axial stop can be formed completely by the bearing. The axial stop can form an axial stop in only one axial direction. In the opposite axial direction, a second axial stop can form a further axial stop. The axial stop limits the relative movement of inner sleeve to outer sleeve in the axial direction. The axial stop acts when, during the relative adjustment of inner sleeve and outer sleeve, the first stop strikes the second stop (axial stop position). A relative adjustment beyond this in this axial direction is thus prevented. The axial stop can be formed in the intermediate space. This serves to integrate the axial stop into the bearing.

The stops each comprise a contact surface, the contact surfaces facing each other. In the axial stop position, the contact surfaces of the stops of the axial stop contact each other. The contact surface on the inner sleeve side can be formed by the inner sleeve/the stop itself or by the elastomer body and/or elastomer buffer. The contact surface on the outer sleeve side can be formed by the outer sleeve/the stop itself or by the elastomer body and/or elastomer buffer. An axial stop with at least one elastomeric contact surface serves to reduce noise and is material-friendly. In addition, the elastomeric contact surface leads to a progressive stop behavior. This progressive stop behavior can be tuned even more finely if an axial stop is designed with two elastomeric contact surfaces. A stop of an axial stop and/or radial stop can be formed by a stop geometry, for example by an annular flange or by an annular groove or an annular step. A stop geometry can form a plurality of stops.

The inner sleeve and/or the outer sleeve can each form or have the stop geometry, which projects in the radial direction and runs in the circumferential direction. The (respective) stop geometry can form the corresponding stop. The annular shape serves as a uniform stop which distributes a force as widely as possible. The stops can be formed in one piece by the inner sleeve and outer sleeve themselves. This avoids additional components. The inner sleeve can be in one piece. The inner sleeve can be the radially farthest inward component of the bearing. This avoids additional components. The inner sleeve can have a through-bore in the axial direction. This serves to receive a fastening element, for example a screw. The bearing may consist exclusively of the inner sleeve, the outer sleeve and the elastomer body. This avoids additional components.

The clearance can be provided between the two contact surfaces of the stops of the axial stop. In the axial stop position, the length of the clearance is zero. The clearance can extend parallel to the longitudinal axis in the axial direction. The axial stop can rest in the load path between inner sleeve, elastomer body and outer sleeve.

The elastomer body can directly connect the inner sleeve and outer sleeve to each other. This reduces a radial installation space requirement. The elastomer body is connected in a materially bonded manner to only one of the inner sleeve and outer sleeve, in order to make its complex geometry shapeable. If the elastomer body is connected to the inner sleeve in a materially bonded manner but not to the outer sleeve, then the tool geometry of the vulcanization mold can be designed in almost any desired way for imaging the outer shape of the elastomer body. This allows maximum freedom as regards the design of the outer geometry of the elastomer body and thus good tunability of the stiffnesses and clearances in conjunction with the mounted outer sleeve. Likewise, the freedom of design of the elastomer body is great if the latter is merely fixed to the outer sleeve and the unit composed of outer sleeve and elastomer body is subsequently mounted around the inner sleeve. This applies in particular if the outer sleeve is divided into two parts. The elastomer body can bear against the other of the inner sleeve and outer sleeve in a manner free of material bonding. The elastomer body can be in one piece and/or the single elastomer body can be in the intermediate space. This avoids additional components.

According to one embodiment of the bearing, it can comprise at least one axial stiffener comprising an annular recess running in the circumferential direction on one of the inner sleeve and outer sleeve and an annular projection running in the circumferential direction on the other of the inner sleeve and outer sleeve, which annular projection extends in the radial direction in the direction of the annular recess, wherein the annular projection is elastically supported on the annular recess via the elastomer body, with the annular recess and the annular projection may have an overlap with each other in the axial direction. The axial stiffness can be set by the axial stiffener. The elastomer body can completely fill the intermediate space between annular recess and annular projection. This serves to increase the axial stiffness. The overlap in the axial direction likewise serves to increase the axial stiffness. The bearing may comprise a single axial stiffener. This serves for an axially compact construction.

According to one embodiment of the bearing, the outer sleeve can be formed from two shell halves. The separation of the shell halves at their longitudinal gap edges can extend in the axial direction. The two-part outer sleeve can serve in a simple manner to form the axial stop. As a result, the shell halves can be mounted in the radial direction, as a result of which undercuts caused by axial stops in the axial direction become irrelevant for the vulcanization. It is furthermore advantageous that the division of the outer sleeve into two shell halves maximizes the freedom of design of the elastomer body, since undercuts could otherwise only be imaged in the vulcanization tool to a very limited extent.

According to one embodiment of the bearing, the first stop and/or the second stop can carry an axial elastomer buffer and/or a radial elastomer buffer. The stops are the stops of an axial stop. The elastomer buffer(s) can be formed in one piece from the elastomer body and/or can be an elastomer coating. The elastomer buffer(s) can be connected to the stop in a materially bonded manner. This prevents slipping and increases the progression and the service life of the stop system. The axial elastomer buffer can limit the axial clearance. The axial elastomer buffer(s) can be arranged in the axial direction at a distance from the contact surface of the other stop. The radial elastomer buffer can limit a radial clearance. The radial elastomer buffer can be arranged in the radial direction at a distance from the contact surface of a stop of a radial stop.

According to one embodiment of the bearing, the elastomer body can be a thermoplastic elastomer body. This is advantageous, particularly in the case of a materially bonded connection to the shell halves, if the shell halves are produced from a plastic. In this case, the thermoplastic elastomer body can be formed together with the shell halves in a two-component process. This reduces manufacturing costs and allows a high degree of geometry complexity. Such shell halves with an adhered elastomer body can be mounted around the inner sleeve in an assembly process and thus form the bearing.

According to one embodiment of the bearing, the inner sleeve can form a screw head receiving space at one end, which space has an overlap in the axial direction, at least in regions, with the annular recess. The screw head receiving space can, for example, receive a screw head or a screw nut or a centering pin at least in sections. This reduces an axial installation space requirement. The overlap in the axial direction likewise serves for an axially very compact bearing. The outer circumference of the inner sleeve radially of the screw head receiving space may be larger than the inner circumference of the annular projection on the outer sleeve. This section of the inner sleeve thus has an overlap with the annular projection in the axial direction. In the case of axially adjacent positioning of the screw head receiving space and the annular projection, the section of the inner sleeve forming the screw head receiving space can serve as an axial support of the annular projection in the axial stiffener. This nesting of annular recess, screw head receiving space, centering pin receiving space and screw-through bore reduces an axial and radial installation space requirement. The screw head receiving space can be a portion of the through-bore in the axial direction.

According to one embodiment of the bearing, the inner sleeve can have a screw-through bore, wherein the annular recess is located on the outer circumference of the screw-through bore in the radial direction. The screw-through bore can be a portion of the through-bore in the axial direction. The screw-through bore can open axially at one end directly into the screw head receiving space. This reduces an axial installation space requirement. The screw-through bore can be cylindrical. This permits an annular recess in the inner sleeve with the smallest possible outer diameter in its base. The inner diameter of the screw-through bore can be smaller than the inner diameter of the screw head receiving space. This reduces a radial installation space requirement.

According to one embodiment of the bearing, the inner sleeve can have a centering pin receiving space, arranged axially at the other end of the screw head receiving space. In this case, the screw-through bore can open axially directly into the centering pin receiving space. This reduces an axial installation space requirement. A centering pin, for example from a battery mounting, a motor or assembly mounting, can be introduced into the centering pin receiving space and fixed there by a fixing element, for example by a screw. The outer circumference of the inner sleeve radially of the centering pin receiving space may be larger than the inner circumference of the annular projection on the outer sleeve. This portion of the inner sleeve thus has an overlap with the annular projection in the axial direction. In the case of axially adjacent positioning of the centering pin receiving space and the annular projection, the portion of the inner sleeve forming the centering pin receiving space can serve as an axial support of the annular projection in the axial stiffener. This nesting of annular recess, screw head receiving space, centering pin receiving space and screw-through bore reduces an axial and radial installation space requirement. The centering pin receiving space can be a portion of the through-bore in the axial direction.

According to one embodiment of the bearing, the inner diameter of the annular projection can be smaller than the inner diameter of the stop on the one of the inner sleeve and outer sleeve and/or smaller than the outer diameter of the stop on the other of the inner sleeve and outer sleeve. If a plurality of stops are located on the inner sleeve/outer sleeve, this can apply to all of the stops there. This geometric relationship serves for a large radial extent of the annular projection and for a compact construction, so that the overlap thereof with the annular recess can likewise be as large as possible. It furthermore serves for a compact construction. An inner diameter is present when the stop or annular projection is located on the outer sleeve. An outer diameter is present when the stop or annular projection is located on the inner sleeve. Said stop is the first or second stop of an axial stop, depending on the location.

According to one embodiment, the inner sleeve can have a cylinder surface portion in each case axially on both sides of the annular recess. If the elastomer body is vulcanized on the inner sleeve side, its extent in the axial direction in the region of the cylinder surface portion can be varied to a small extent. This small variation in the extent leads to an adaptation of the stiffnesses in a small range, without the damage mechanisms and also the locations of the expansion peaks changing significantly. The whole applies in particular with an otherwise constant geometry, in particular of the inner sleeve and outer sleeve. Consequently, the cylinder surface portions increase the modular use and simple tuning of the stiffnesses of the design using the same inner and outer sleeve. The cylinder surface portions can be separated from the annular recess in the axial direction.

According to one embodiment of the bearing, the bearing can comprise a radial stop, comprising a third stop running in the circumferential direction on one of the inner sleeve and outer sleeve and a fourth stop running in the circumferential direction on the other of the inner sleeve and outer sleeve, wherein the third stop and the fourth stop can have an overlap with each other in the radial direction and a radial clearance between their contact surfaces. The radial stop limits the relative movement of inner sleeve to outer sleeve in the radial direction.

The stops each have a contact surface, with the contact surfaces facing each other. In the radial stop position, the contact surfaces of the stops of the radial stop contact each other. The contact surface on the inner sleeve side can be formed by the inner sleeve itself or by the elastomer body and/or elastomer buffer. The contact surface on the outer sleeve side can be formed by the outer sleeve itself or by the elastomer body and/or elastomer buffer. A radial stop having at least one elastomeric contact surface serves to reduce noise and is gentle on the material. A radial stop having two elastomeric contact surfaces leads to a softer stop behavior.

The radial clearance can be provided between the two contact surfaces of the stops of the radial stop. In the radial stop position, the length of the radial clearance is zero. The clearance can extend perpendicular to the longitudinal axis in the radial direction. The axial stop can rest in the load path between inner sleeve, elastomer body and outer sleeve.

One of the stops of the axial stop and one of the stops of the radial stop may be formed by the same stop geometry. This serves for a compact construction. A stop geometry may form two or three stops, for example two stops of the two axial stops and one stop of the radial stop. This serves for a further compact construction. All of the stops of the first and second axial stop and both stops of the radial stop may be each formed by the same stop geometry to the respective side of the intermediate space. This serves for an even more compact construction. In the latter case, a stop geometry, for example an annular flange, can form a further stop geometry, for example an annular groove, in the radial direction. The first axial stop can be formed on one axial side of the stop geometry/of the annular flange. The second axial stop can be formed on the opposite axial side of the stop geometry/of the annular flange. The radial stop can be formed in the radial direction of the stop geometry/of the annular flange. The stop geometry/the annular flange thus advantageously has a triple action.

According to one embodiment of the bearing, the outer sleeve can have a mounting stop on the outer circumference. The outer sleeve can have just a single mounting stop. The mounting stop can be arranged axially at one end. The outer sleeve can be free of mounting stops at the axial other end. This serves for oriented installation and precise axial positioning. The mounting stop can be an annular collar. The mounting stop serves firstly as an end stop when the bearing is arranged in, for example pressed into, the fastening opening, and secondly the mounting stop predefines a direction of introduction into the fastening opening.

According to one embodiment of the bearing, the outer sleeve can have an outer-circumferential mounting surface which defines an imaginary cylinder, wherein the first stop and/or the second stop are located at least partially within the imaginary cylinder. Alternatively or additionally, the third and/or fourth stop can also be located at least partially within the imaginary cylinder. In an embodiment, all of the stops are located at least partially, or completely, within the imaginary cylinder. This serves for a radially compact construction. By way of the mounting surface, the bearing bears in the radial direction against the fastening opening, which can be with an interference fit.

According to one embodiment of the bearing, the annular recess and/or the annular projection can be V-shaped in longitudinal section, the mutually facing surfaces of the annular recess and annular projection may run parallel to each other. The V-shape results in compressive stresses and thrust in the elastomer body for a soft but progressive radial characteristic.

According to one embodiment, the bearing can comprise a second axial stop, comprising
the/a first stop running in the circumferential direction on one of the inner sleeve and outer sleeve and
a second stop running in the circumferential direction on the other of the inner sleeve and outer sleeve, wherein
the first stop and the second stop have an overlap with each other in the axial direction and an axial clearance between their contact surfaces.

The second axial stop can act in the opposite direction with respect to the first axial stop. The relative movement of inner sleeve to outer sleeve in both opposite axial directions is limited by two axial stops. The first axial stop and the second axial stop can have a common stop.

According to embodiments, a bearing arrangement is furthermore proposed, comprising
a bearing as disclosed and
a fastening opening in which the bearing is fixed with a press fit.

The advantages described above with respect to the bearing also pertain to the bearing arrangement, and reference is hereby made thereto. The bearing arrangement can comprise a connection structure which has the fastening opening.

The bearing arrangement may have two such bearings in each case in a fastening opening, wherein said bearings are at a distance from each other which is smaller than twice the outer bearing diameter or smaller than twice the diameter of the imaginary cylinder. The bearings can be arranged adjacent to each other in the radial direction. If two bearings are closely spaced apart from each other radially, they can, when viewed together, act as a bearing with high torsional stiffness. It is then also possible to refer to a torsion-resistant bearing system or torsion-resistant bearing arrangement.

The bearing may project at least at one end out of the fastening opening; the axial stop may be located at least partially outside the fastening opening. As a result, the fastening opening can be short.

The embodiments and advantages described with respect to an axial stop or with respect to a stop of an axial stop may equally also apply to the at least one other axial stop or with respect to another stop of an axial stop. If components are disclosed several times, embodiments and advantages that are described only for one of the components should also be regarded as being disclosed in an optional manner for the other corresponding components. Axial and axial direction run parallel to the longitudinal axis. Radial and radial direction run perpendicular to the longitudinal axis. Circumference and circumferential direction run around the longitudinal axis.

### BRIEF DESCRIPTION OF THE DRAWINGS

Further features, details and advantages of the disclosure will become apparent from the wording of the claims and from the following description of exemplary embodiments with reference to the drawings, in which:

FIG. 1 shows a longitudinal sectional view of a bearing and

FIG. 2 shows a further longitudinal sectional view of a bearing.

### DETAILED DESCRIPTION

In the figures, identical or mutually corresponding elements are each denoted by the same reference signs and are therefore not described again, unless this is expedient. Features already described are not described again, so as to avoid repetition, and are applicable to all elements with identical or mutually corresponding reference signs, unless explicitly excluded. The disclosures contained in the entire description can be applied analogously to the same parts with the same reference signs or the same component designations. Also, the positional indications selected in the description, such as, for example, top, bottom, side, etc., are related to the directly described and illustrated figure and, in the event of a positional change, are to be transferred analogously to the new position. Furthermore, individual features or combinations of features from the different exemplary embodiments shown and described can also represent independent or inventive solutions or solutions according to the disclosure.

A radial direction R extends perpendicular to a longitudinal axis L. A circumferential direction U extends around the longitudinal axis L. An axial direction A lies along the longitudinal axis L.

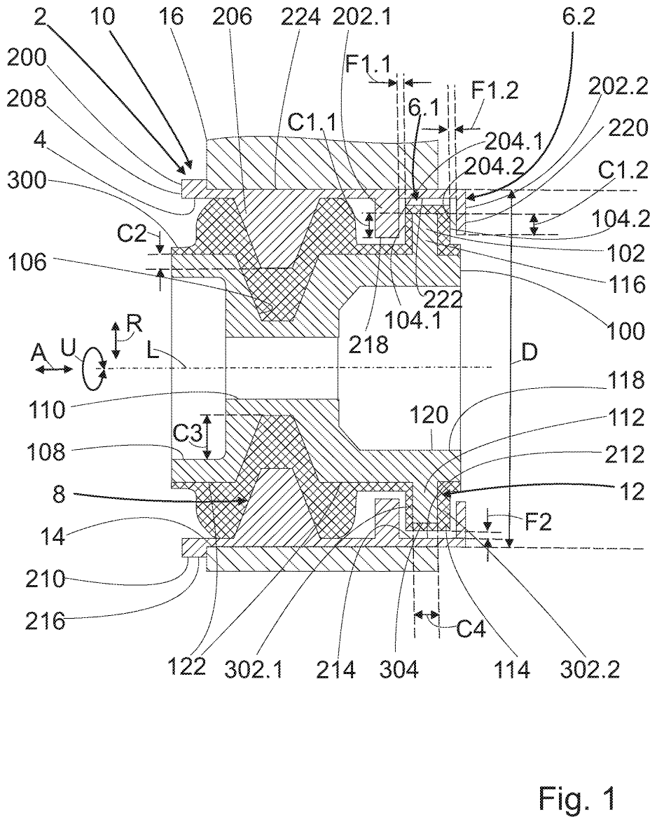

FIG. 1 shows a longitudinal section through a bearing 2, through which there runs a longitudinal axis L. The bearing 2 comprises a one-piece inner sleeve 100, a one-piece outer sleeve 200 which surrounds the outer circumference of the inner sleeve 100 to form an intermediate space 4, and a one-piece elastomer body 300 in the intermediate space 4, which elastomer body connects the inner sleeve 100 elastically and directly to the outer sleeve 200. The inner sleeve 100 has a through-bore 118 in the axial direction A. The outer sleeve 200 is formed from two shell halves 208, 210.

The elastomer body 300 is connected in a materially bonded manner only to the inner sleeve 100 and bears on the outer sleeve 200 without material bonding. The elastomer body 300 is in one piece and the single elastomer body in the intermediate space 4.

The bearing 2 has two axial stops 6.1, 6.2. Each axial stop 6.1, 6.2 limits the relative movement of the inner sleeve 100 to the outer sleeve 200 in the axial direction A.

Each axial stop 6.1, 6.2 comprises a first stop 102 running in the circumferential direction U on the inner sleeve 100. Each axial stop 6.1, 6.2 furthermore comprises a second stop 202.1, 202.2 running in the circumferential direction U on the outer sleeve 200. The first stop 102 and the second stop 202.1, 202.2 of each axial stop 6.1, 6.2 have an overlap C1.1, C1.2 with each other in the axial direction A and an axial clearance F1.1, F1.2 between their contact surfaces 104.1, 104.2, 204.1, 204.2. The respective contact surfaces 104.1, 104.2, 204.1, 204.2 of each axial stop 6.1, 6.2 face each other.

In the axial stop position, the contact surfaces 104.1, 104.2, 204.1, 204.2 contact each other. The contact surfaces 104.1, 104.2 on the inner sleeve side are formed by the elastomer body 300. The contact surfaces 204.1, 204.2 on the outer sleeve side are formed by the outer sleeve 200 itself.

The clearances F1.1, F1.2 are provided between the respective contact surfaces 104.1, 104.2, 204.1, 204.2. The clearances F1.1, F1.2 extend parallel to the longitudinal axis L.

The inner sleeve 100 has an annular flange 116, which represents a stop geometry and defines the first stop 102 for both axial stops 6.1, 6.2. The outer sleeve 200 has two annular flanges 218, 220, which are arranged on both sides of the annular flange 116 on the inner sleeve side and represent stop geometries. The annular flanges 218, 220 define the second stops 202.1, 202.2. The two annular flanges 218, 220 on the outer sleeve side define an annular groove 222. The annular flanges 116, 218, 220 project in the radial direction R and run in the circumferential direction U.

The axial stops 6.1, 6.2 are formed completely by the bearing 2. Each axial stop 6.1, 6.2 forms an axial stop in only one axial direction, the directions of effect being opposite each other. The axial stops 6.1, 6.2 are formed in the intermediate space 4.

The first stop 102 carries an axial elastomer buffer 302.1, 302.2 and a radial elastomer buffer 304. The elastomer buffers 302.1, 302.2, 304 are formed in one piece from the elastomer body 300 and are formed as an elastomer coating. The elastomer buffers 302.1, 302.2, 304 are connected to the stop 102 in a materially bonded manner.

The bearing 2 also has an axial stiffener 8. The axial stiffener 8 comprises an annular recess 106 running in the circumferential direction U on the inner sleeve 100 and an annular projection 206 running in the circumferential direction U on the outer sleeve 200. The annular projection 206 extends in the radial direction R in the direction of the annular recess 106. The annular projection 206 is elastically supported on the annular recess 106 via the elastomer body 300, wherein the annular recess 106 and the annular projection 206 have an overlap C2 with each other in the axial direction A. The elastomer body 300 completely fills the intermediate space between the annular recess 106 and the annular projection 206. To the left and right of the annular recess 106, there is an adjoining cylinder surface portion 122 in each case. The inner diameter of the annular projection 206 is smaller than the outer diameter of the first stop 102 on the inner sleeve 100 and smaller than the inner diameter of the stops 202.1, 202.2 on the outer sleeve 100. The annular recess 106 and the annular projection 206 are V-shaped in longitudinal section. The mutually facing surfaces of annular recess 106 and annular projection 206 extend parallel to each other.

The through-bore 118 of the inner sleeve 100 comprises a plurality of portions. The inner sleeve 100 forms, at one end, a screw head receiving space 108 which, with the annular recess 106, has, at least in regions, an overlap C3 in the axial direction A. The screw head receiving space 118 is a portion of the through-bore 118. This is adjoined by a screw-through bore 110 of the inner sleeve 100, wherein the annular recess 106 is located on the outer circumference of the screw-through bore 110 in the radial direction R. The screw-through bore 110 is a further portion of the through-bore 118. The screw-through bore 110 is cylindrical, and the diameter of the screw-through bore 110 is smaller than the diameter of the screw head receiving space 108. A centering pin receiving space 120 adjoins the screw-through bore 110; a centering pin, which is for example part of a battery, a motor or an assembly, can be inserted in a form-fitting manner into said space and fixed there by a screw. The diameter of the screw-through bore 110 is smaller than the diameter of the centering pin receiving space 120. The screw head receiving space 118 and the centering pin receiving space 120 are formed on opposite axial sides of the inner sleeve 100.

The bearing 2 also has a radial stop 12. The latter comprises a third stop 112 running in the circumferential direction U on the inner sleeve 100 and a fourth stop 212 running in the circumferential direction U on the outer sleeve 200. The third stop 112 and the fourth stop 212 have an overlap C4 with each other in the radial direction R and a radial clearance F2 between their contact surfaces 114, 214. It can be seen that the annular flange 116, as stop geometry, forms the two first stops 102 of the two axial stops 6.1 and 6.2 and the third stop 112 of the radial stop 12. The radial stop 12 limits the relative movement of inner sleeve 100 to outer sleeve 200 in the radial direction R. The stops 112, 212 each have a contact surface 114, 214, which face each other. The contact surface 114 on the inner sleeve side is formed by the elastomer body 300. The contact surface 214 on the outer sleeve side is formed by the outer sleeve itself. The radial clearance F2 lies between the two contact surfaces 114, 214. The clearance F2 extends perpendicular to the longitudinal axis L in the radial direction R.

The outer sleeve 200 has an outer-circumferential mounting surface 224 which defines an imaginary cylinder D, wherein all of the stops 102, 202.1, 202.2, 112, 212 are located completely within the imaginary cylinder D. By way of the mounting surface 224, the bearing 2 bears in the radial direction R against a fastening opening 14 of a connection structure 16, preferably with an interference fit. A bearing arrangement 10 comprises the bearing 2 in the fastening opening 14. The bearing 2 projects axially at both ends out of the fastening opening 14, the first axial stop 6.1 being located inside and the second axial stop 6.2 being located outside the fastening opening 14.

The outer sleeve 200 has a single mounting stop 216 on the outer circumference and axially at one end. The outer sleeve 200 is free of mounting stops at the axial other end. The mounting stop 216 is an annular collar. It rests against the connection structure.

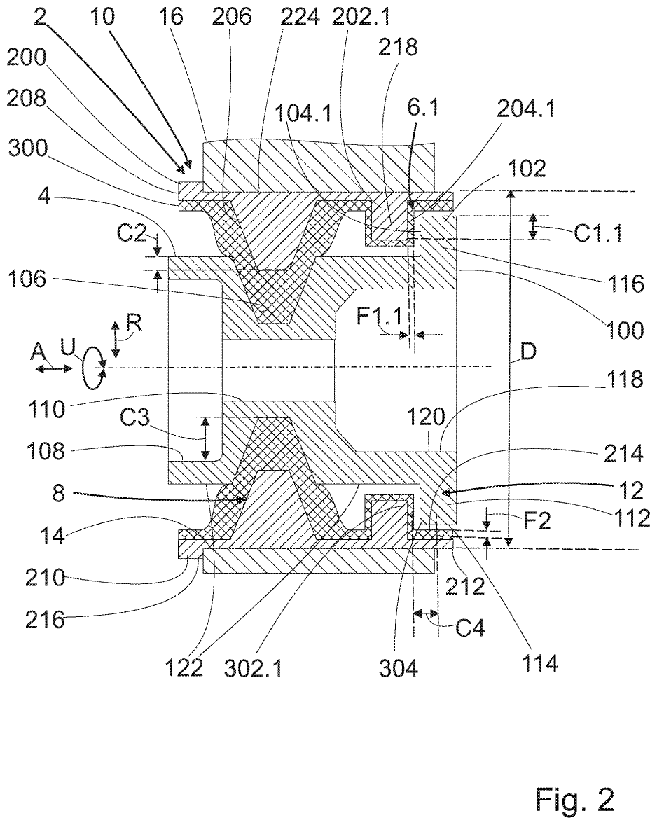

FIG. 2 shows a further bearing 2 in longitudinal section. To avoid repetition, only the differences from FIG. 1 will be described below with reference to FIG. 2. Features that have already been described but are not repeated again are to be regarded as it were as disclosed and described.

The bearing 2 now has only one axial stop 6.1 instead of two axial stops 6.1, 6.2. The elastomer body 300 is now connected to the outer sleeve 200 in a materially bonded manner, while it bears against the inner sleeve 100 in a manner free of material bonding. Consequently, the location of the elastomer buffers 302.1, 302.2, 304 also changes from the inner sleeve 100 to the outer sleeve 200. The contact surface 104.1, 114 on the inner sleeve side is formed by the inner sleeve 100 itself. The contact surfaces 204.1, 214 on the outer sleeve side are formed by the elastomer body 300.

The invention is not limited to one of the above-described embodiments, but rather can be modified in a variety of ways. All of the features and advantages that are apparent from the claims, the description and the drawing, including structural details, spatial arrangements and method steps, can be significant to the disclosure both individually and in a wide variety of combinations. All combinations of at least two of the features disclosed in the description, the claims and/or the figures fall within the scope of the disclosure. To avoid repetition, features that are disclosed with regard to the device are also to be considered to be disclosed and claimable with regard to the method. Likewise, features that are disclosed with regard to the method are also to be considered to be disclosed and claimable with regard to the device.

1. A bearing with a longitudinal axis, comprising:
an inner sleeve,
an outer sleeve which surrounds an outer circumference of the inner sleeve to form an intermediate space, and
an elastomer body in the intermediate space, which elastomer body elastically connects the inner sleeve to the outer sleeve,
wherein the elastomer body is connected in a materially bonded manner only to the inner sleeve or only to the outer sleeve,
wherein the bearing comprises at least one axial stop comprising
a first stop running in a circumferential direction on one of the inner sleeve and outer sleeve and
a second stop running in the circumferential direction on the other of the inner sleeve and the outer sleeve, wherein
the first stop and the second stop have an overlap with each other in the axial direction and an axial clearance between their contact surfaces.

2. The bearing as claimed in claim 1, including at least one axial stiffener, comprising:
an annular recess running in the circumferential direction on one of the inner sleeve and outer sleeve, and
an annular projection running in the circumferential direction on the other of the inner sleeve and outer sleeve, which annular projection extends in a radial direction in a direction of the annular recess,
wherein the annular projection is elastically supported on the annular recess via the elastomer body,
the annular recess and the annular projection having an overlap with each other in the axial direction.

3. The bearing as claimed in claim 1, wherein the outer sleeve is formed from two shell halves.

4. The bearing as claimed in claim 1, wherein the first stop and/or the second stop carries an axial elastomer buffer and/or a radial elastomer buffer.

5. The bearing as claimed in claim 1, wherein the elastomer body is a thermoplastic elastomer body.

6. The bearing as claimed in claim 2, wherein the inner sleeve forms, at one end, a screw head receiving space which, with the annular recess, has, at least in regions, an overlap in the axial direction.

7. The bearing as claimed in claim 1, wherein the inner sleeve has a screw-through bore, wherein an annular recess is located on an outer circumferential side of the screw-through bore in a radial direction.

8. The bearing as claimed in claim 1, wherein an inner diameter of an annular projection is smaller than an inner diameter of the stop on one of the inner sleeve and outer sleeve and/or smaller than an outer diameter of the stop on the other of the inner sleeve and outer sleeve.

9. The bearing as claimed in claim 1, wherein preceding the inner sleeve has in each case one cylinder surface portion axially on both sides of the annular recess.

10. The bearing as claimed in claim 1, wherein the bearing comprises a radial stop, comprising:
a third stop running in the circumferential direction on one of the inner sleeve and outer sleeve and
a fourth stop running in the circumferential direction on the other of the inner sleeve and outer sleeve, wherein
the third stop and the fourth stop have an overlap with each other in the radial direction and a radial clearance between their contact surfaces.

11. The bearing as claimed in claim 1, wherein the outer sleeve has an outer-circumferential mounting surface which defines an imaginary cylinder, wherein the first stop and/or the second stop are located at least partially within the imaginary cylinder (D).

12. The bearing as claimed in claim 1, wherein an annular recess and/or an annular projection are/is V-shaped in longitudinal section, and mutually facing surfaces of the annular recess and the annular projection run parallel to each other.

13. The bearing as claimed in claim 1, further comprising a second axial stop, comprising:
the/a first stop running in the circumferential direction on one of the inner sleeve and outer sleeve and
a second stop running in the circumferential direction on the other of the inner sleeve and outer sleeve, wherein
the first stop and the second stop have an overlap with each other in the axial direction and an axial clearance between their contact surfaces.

14. A bearing arrangement, comprising:
a bearing as claimed in claim 1; and
a fastening opening in which the bearing is fixed with an interference fit.
